(19) United States
(12) Patent Application Publication
(10) Pub. No.: US 2018/0048921 A1
(43) Pub. Date: Feb. 15, 2018

(54) REAL-TIME PLAYBACK DIAGNOSTICS

(71) Applicant: Microsoft Technology Licensing, LLC, Redmond, WA (US)

(72) Inventors: Vishal Sood, Bothell, WA (US); Beverly Loh, Woodinville, WA (US); Amit Rajput, Seattle, WA (US)

(21) Appl. No.: 15/235,917

(22) Filed: Aug. 12, 2016

(51) Int. Cl. H04N 21/2387; G11B 27/36; H04N 21/488; H04N 21/61; H04N 21/24

(52) U.S. Cl. CPC H04N 21/2387; H04N 21/6125; H04N 21/24; H04N 21/4882; G11B 27/36

(57) ABSTRACT

A method includes obtaining playback experience data indicative of playback quality of a playback, determining a playback score for the playback based on the obtained playback experience data, analyzing the playback score to determine whether a playback issue is present, and providing a notification at the client indicating that the playback issue is present.

### DESCRIPTION OF THE DRAWING FIGURES

For a more complete understanding of the disclosure, reference is made to the following detailed description and accompanying drawing figures. Similar reference numerals may be used to identify corresponding elements in the detailed description and figures.

FIG. 1 is a block diagram of a client device having real-time playback diagnostics and notifications in accordance with one example.

FIG. 2 is a flow diagram of a computer-implemented method for real-time playback diagnostics and notifications in accordance with one example.

FIG. 3A illustrates an example video playback event timeline that may be experienced during video streaming.

FIG. 3B illustrates exemplary rendering and buffering for video content corresponding to the video playback event timeline of FIG. 3A at one point in time.

FIG. 3C illustrates exemplary video content rendering and buffering corresponding to the video playback event timeline of FIG. 3A at a subsequent point in time.

FIG. 4A illustrates another example video playback event timeline that may be experienced during video streaming.

FIG. 4B illustrates exemplary rendering and buffering timing for video content corresponding to the video playback event timeline of FIG. 4A at one point in time.

FIG. 4C illustrates an example video content rendering and buffering video content for timing of video playback corresponding to the event timeline of FIG. 4A at a subsequent point in time.

FIG. 5 is a block diagram of a client device/computing environment in accordance with one example for implementation of the disclosed methods and systems.

FIG. 6 is a block diagram of a client server model for real-time video playback diagnostics and notifications.

The disclosed devices may assume various forms. Specific examples are illustrated in the drawing figures (and are hereafter described) with the understanding that the disclosure is intended to be illustrative. The disclosure is not intended to limit the invention to the specific examples described and illustrated herein.

### DETAILED DESCRIPTION

Video streaming players attempt to provide both excellent picture quality and uninterrupted playback. Issues with picture quality and playback interruptions can arise when computing, network, or content conditions are unsuitable for streaming. Deteriorations in picture quality and playback interruptions degrade the playback experience of the end user when they become visually perceptible.

Real-time diagnostics and notifications for video playback are provided. Playback issues are addressed by obtaining data indicative of conditions that contribute to the environment of the video playback session. A playback score is generated from the obtained data to quantify the quality of the video playback session in real-time. Streaming and other playback issues may be detected when the playback score exceeds a threshold.

The use of a playback score may address the complexity of factors that influence the quality of the playback environment. For instance, the playback score may be determined from data relating to disparate factors such as network connectivity, processor capabilities, and content type. The data may be indicative of events occurring in the player. The data may be indicative of, or otherwise associated with, event type, event trigger, event intensity, and event duration. The data may be indicative of queried data associated with the rendered video stream.

In some examples, video players provide the playback diagnostics in tandem with adaptive playback features enhancing the resolution or mitigation of playback issues during streaming. Changes in the stream that are implemented by the adaptive playback features may also serve as inputs to the playback score. Any remaining playback issues are also then reflected in the playback score. Playback issues may include dropped frames, resolution changes, and any other changes that may be noticeable to the end user.

The playback score is indicative of a playback issue when a threshold is exceeded. If a playback issue is detected, the end user is notified in real time. The real-time notification provides an immediate indication to the end user that a playback issue has been detected by the video player. End user confidence in the player, streaming service, etc. may accordingly be improved. The notification may also request consent from the end user to forward, send, or distribute detailed information about the playback issue. The consent allows the video player to package detailed information about a streaming experience. The packaged playback issue data can then be sent to one or more parties without violating the privacy of the end user. Recipients of the packaged playback issue data may include companies or other entities involved in resolving and improving the streaming experience.

The playback assessment and notification of the disclosed methods and systems provides detailed and organized data to multiple entities, eliminating the need for individual data collection by each video player, content provider, or other service. The disclosed methods and systems also provide contributing entities with access to data that cannot otherwise be obtained. The data access may also include limiting the amount of playback data to the data associated with the cause of the playback issue. Data may thus be identified and disseminated in a controlled and targeted manner, instead of merely transmitting all the diagnostic data available from a video streaming session.

The playback experience (e.g., quality of the rendered video stream) may be characterized by picture quality, picture size, quality of the video player, and quality of the network connection. The playback experience may also be influenced by the quality of the media content, encryption of the content, encoding of the content, and the processing capabilities of the device on which the content is streamed. A desired threshold for playback experience quality is the threshold at which a change in video quality is perceptible to the human eye. The benchmark of playback experience quality may vary in some examples. A playback score exceeding the playback threshold thus indicates a playback issue. Accordingly, the playback score may be compared to a playback threshold to identify whether a perceptible degradation of the rendered video stream has occurred.

The disclosed methods and systems provide a mechanism to diagnose playback issues and provide notifications to the end user. For example, a ticket identification system (e.g., associated with a troubleshooting service associated with the video player or content provider) may be used. The playback issue and diagnostic data may also be distributed to many contributing parties along with the ticket identification number (ticket ID). Thus, the playback issue and diagnostic data can be identified amongst the many companies and parties that are associated with providing a video stream. Associating the collected event data with a ticket identification provides improved communication between affected service providers to efficiently address specific issues. Communication is further improved between the end user (e.g., viewer) and service providers. For example, a ticket identification is sent with the diagnostic information to a developer associated with the video player. The ticket ID may be generated by the video player during the video streaming session that is compatible with a ticket support system of the video player. Upon resolution of a specific issue, the developer may follow up with the end user by referencing the ticket ID.

The disclosed methods and systems provide diagnostics despite various complicating factors, including, for instance, the intertwined relationships of services and content from multiple sources. Playback experience is improved by identifying and resolving issues from multiple sources. For example, compensation for fluctuations in network bandwidth may be provided by temporarily lowering the quality of the video stream to prevent interruption in playback. However, uninterrupted playback and high quality audio-visual output are both metrics in determining the overall quality of the playback experienced by the end user.

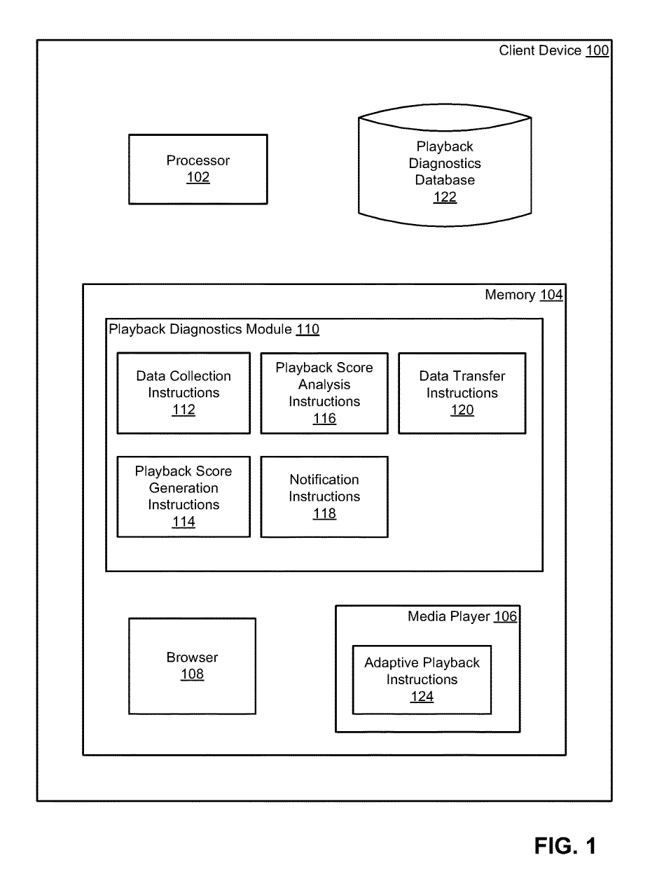

FIG. 1 depicts a client device 100 configured to implement real-time playback diagnostics in connection with video and other streaming. The playback may present any type of media content and originate from a variety of sources (e.g., video streaming service, video player, online video platform, or other content distribution platform). To implement the playback and diagnostics, the client device 100 includes a processor 102 and a memory 104 in which a number of instruction sets are stored for execution by the processor 102. The processor 102 may be or include one or more processors, such as a general purpose processor, microprocessor, central processing unit (CPU), and/or graphics processing unit (GPU). The memory 104 may be or include one or more transient and/or non-transient memories, such as random access memory (RAM), read-only memory (ROM), flash memory, and/or data storage devices or units (e.g., a hard drive). The instruction sets may be arranged in modules, as applications, or other groups of instructions. In this example, the memory 104 includes instructions of a media player 106 and a browser 108. Execution of the instructions of either one or both of the media player 106 and the browser 108 by the processor 102 may configure the processor 102 to implement the playback. In other cases, the memory 104 includes the instructions of one of the media player 106 and the browser 108. Either way, real-time diagnostics and notifications may be provided via the media player 106 and/or the browser 108 as described herein.

The client device 100 may be any type of computing device or display device. Examples include desktop computers, laptop, tablet, and other portable computers, phones, media players, e-readers, game controllers, televisions, or any other device configured to stream and/or playback media content. The size and form factor of the client device 100 may thus vary. For instance, the client device 100 may range from a handheld or wearable computing device to a wall-mounted display or other large format display screen. The playback diagnostics and notification techniques are accordingly useful with a variety of client devices 100 equipped with media player capabilities.

The media player 106 may be or include a client-side application, web-hosted player, a browser-based application, or other application. Various web-hosted players may be used, including, for instance, Azure Media Player, or another vendor or service offering online video platforms and video player applications. Alternatively or additionally, the media player 106 may use or access online video frameworks and platforms, such as Silverlight. The media player 106 may be capable of playback of various types of media content, and is accordingly not limited to video content.

The content streamed by the video player 106 may include any type of media content, such as television and radio broadcasts, videos, movies, music, music videos, live event broadcasts, and/or original user content. The content may be provided for online streaming by any content provider or other service. Examples include content publishers, broadcast networks, or other media houses. Any type of audio and/or visual content may be provided.

In the example of FIG. 1, the memory 104 includes a playback diagnostics module 110 directed to real-time playback diagnostics and notifications. The module 110 includes a number of instruction sets or other groupings of instructions to configure the processor 102 to implement the real-time playback diagnostics and notifications. Although depicted as a separate module, the module 110 may be integrated with the media player 106 and/or the browser 108 to any desired extent. For instance, the diagnostics functionality may be performed by a module or other component of the media player 106. In some cases, a diagnostics and/or other module of the media player 106 may be configured as scripts hosted on a content distribution network (CDN) and accessed via the browser 108 or other client device application. The diagnostics and/or other module of the media player 106 and/or the playback diagnostics module 110 may include any type of browser-based software instruction sets and/or client application-based software instruction sets. For example, the instructions of the media player 106 and/or the playback diagnostics module 110 may be implemented in JavaScript or in other programming languages. Scripts associated with the modules of the media player 106 and/or the playback diagnostics module 110 may be hosted on a server or in the cloud, but may be entirely executed in the context of the browser 108. In other cases, the instructions of the media player 106, the browser 108, and/or the playback diagnostics module 110 are integrated to a desired extent. The diagnostic notifications provided by the module 110 may be rendered or presented via the same browser session or other user interface element in which the video is streamed, regardless of the extent to which the instructions of the media player 106, the browser 108, and the module 110 are integrated.

In the example of FIG. 1, the playback diagnostics module 110 includes data collection instructions 112, playback score generation instructions 114, playback score analysis instructions 116, notification instructions 118, and data transfer instructions 120, each of which is executable by the processor 102. The instructions of the module 110 are stored in the memory 104. Alternatively or additionally, one or more of the instructions of the module 110 are stored in a distributed manner. In such cases, one or more of the instructions may be stored in memories connected to the client device 100 via a network (see, e.g., FIG. 6). For example, one or more of the instructions may be hosted at a server accessed via the browser 108 or other application of the client device 100. Additional, fewer, or alternative software instruction sets or modules may be provided. For example, the module 110 may not include the data transfer instructions 120 if such instructions are provided by the media player 106.

The data collection instructions 112 are directed to collection of playback experience data. The playback experience data may be associated with a number of different factors affecting playback experience or quality. Playback experience quality may involve, for instance, the quality of the rendered video stream in a particular video streaming session. Playback experience quality may vary based on a combination of operating circumstances of the network, original content quality, client application, web browser, video player, computer processor, content provider, and/or other sources or factors. Execution of the instructions of the data collection module 106 configures a processor to collect playback experience data associated with these sources and factors.

The quality of the playback provided by the media player 106 is influenced by a number of operating conditions, circumstances, and other factors present during the video streaming session. Playback experience data is representative of the operational details that effect the overall playback experience quality of a video streaming session. Playback experience data may be obtained as raw data received or generated by the client device 100 (e.g., such as detectable outputs received by or generated by any component involved in the process of streaming video content on client device 100). In some examples, playback experience data may include data generated in the course of video streaming, data received by the media player 106, data requested by the media player 106, and/or observed data generated or otherwise associated with other processes of the device 100 outside of the media player 106 and/or the browser 108.

Playback experience data may also include the processed representation of raw data. Playback experience data may be inferred from data generated in the course of rendering the video stream. For example, network connectivity may be assessed via metadata associated with the transmission and receipt of content data packets. Interruptions in video playback may be quantified or qualified through playback experience data based on network bandwidth and/or interruptions in network connectivity.

The data collection instructions 112 may access or otherwise obtain data associated with identified network conditions, metadata associated with the video content, logs generated by the video player, data associated with the characteristics of the rendered video stream, etc. The format, structure, and other characteristics of the data collected by the data collection instructions 112 may vary in accordance with the application and/or platform.

The playback score generation instructions 114 determine one or more playback scores based on the playback experience data in real time, e.g., during playback. The playback score(s) may be represented by any data structure. In some cases, each playback score may be a single scalar value. Alternatively, each playback score may be represented by an array, such as an array of sub-scores. Still other data structures may be used, including, for instance, a circular queue. In cases in which the playback score includes multiple sub-scores, each sub-score score may include respective arrays for each sub-score. Each scalar and/or array may include playback score parameters and/or playback score threshold parameters. In some cases, each of the parameters of the arrays may specify the weight or scaling factor applied to the playback score data and/or sub-score data. The playback score and sub-scores may be one or more data sets using additional and/or alternative data structures.

The playback score analysis instructions 116 are directed to detecting or identifying a playback issue based on analysis of the playback score(s). Execution of the playback score analysis instructions 116 configures the processor 102 to compare the playback score(s) with one or more thresholds. A playback issue is identified when the playback score exceeds the playback threshold. In one example, the playback score is indicative of a count of the number of dropped frame events. A playback issue is then identified when the playback score exceeds a threshold of, e.g., five events. The threshold may be any integer or other number, including, zero, such that the threshold is exceeded upon the occurrence of a single instance of an event. In other cases, the threshold is any non-zero number. Other types of comparisons and analyses may be implemented. For example, the playback score may be compared with a range or other distribution of playback scores, including, for instance, cases in which the playback score is not indicative of an event or other count.

In the example of FIG. 1, data indicative of the thresholds or other data used by the analysis instructions 116 is stored in a playback diagnostics database 122. In some cases, the database 122 stores a set of thresholds or other data for comparison or other analysis of various types of playback scores. The database 122 may also store data indicative of previously generated scores and/or the results of previous comparisons or analyses. The data structure arrangement, configuration, and other characteristics of the database 122 may vary. The database 122 may be or include one or more local data storage devices, such as a hard drive. In other cases, some or all of the above-referenced playback diagnostics data is stored remotely, e.g., at a server associated with the playback and/or playback diagnostics.

The notification instructions 118 are directed to providing notifications for display via the media player 106 or the browser 108. The notifications may identify a detected playback issue and may include interactive graphical and/or audio components related thereto. Execution of the notification instructions 118 may cause the processor 102 to analyze the output of the playback score analysis to determine the content of the notification. The notifications generated by the notification instructions 118 may include one or more user interface elements that request a response from the end user. For example, the notification may ask the end user to authorize or consent to the distribution of playback issue data to one or more other parties.

The data transfer instructions 120 are directed to distributing playback issue data. The data transfer instructions 120 are executed by the processor 102 upon receipt of an indication of consent to distribute. The data transfer instructions 120 may then generate output data indicative of the detected playback issue, such as data representative of the notification provided to the end user and/or other error code for the detected playback issue. Other types of data may also be included. For instance, the output data may identify portions of the playback experience data associated with the playback issue. The output data is then disseminated across a network to one or more devices or services, e.g., cloud-hosted services. The output data may include information received from various sources, including, for instance, the client device 100, remote streaming service providers, content originators, and/or other applications.

In the example of FIG. 1, also stored in the memory 104 are adaptive playback instructions 124 directed to adjusting playback in accordance with the playback issue(s) detected by the playback diagnostics module 110. In this case, the adaptive playback instructions 124 are a component of the media player 106. In other cases, the adaptive playback instructions 124 are configured as a discrete module or instruction set used to configure playback by the media player 106 and/or the browser 108. Execution of the adaptive playback instructions 124 configures the processor 102 to correct or otherwise adjust playback in real time, e.g., during playback. The adjustments may prevent or mitigate undesirable effects or other issues in the playback that were previously detected. The adaptive playback instructions 124 may thus prevent or reduce negative impacts to the rendered video stream or other playback.

The adaptive playback instructions 124 may adjust playback not yet presented to the end user. Issues may be detected by the analysis instructions 116 for playback that has not yet been rendered or presented. For instance, the media player 106 may be processing content data sufficiently in advance of rendering so as to leave some time for playback adaption. The analysis instructions 116 may then identify an issue or event that would adversely impact the playback, e.g., the rendered video stream. The adaptive playback instructions 124 may then act on the identified issues or events to prevent or reduce the actual impact on the playback. The adaptive playback module 110 may accordingly implement adjustments before any discernable impact occurs. The real-time determination of a playback score may thus avoid or minimize adverse impacts on playback experience. Alternatively or additionally, the adaptive playback instructions 124 adjust the playback of future content, i.e., content to be presented after the content with which a detected playback issue was associated. In these and other ways, the playback score of the disclosed methods and systems may be used to influence future downloads.

The instructions of the playback diagnostics module 110 may be configured to evaluate and address multiple streaming or other playback sessions. The playback sessions may be associated with one another by virtue of playback via the same media player 106 or browser 108. The playback sessions may include or involve concurrent or serial playback. The media player 106, the browser 108, and/or the playback diagnostics module 110 may associate multiple playback sessions with one another for collective analysis based on a variety of factors, including, for instance, the end user, content, content provider, device identification, and the like. In the example of FIG. 1, associations between playback sessions may affect the frequency, repetition, timing, or other aspects of the notifications generated by the notification instructions 118.

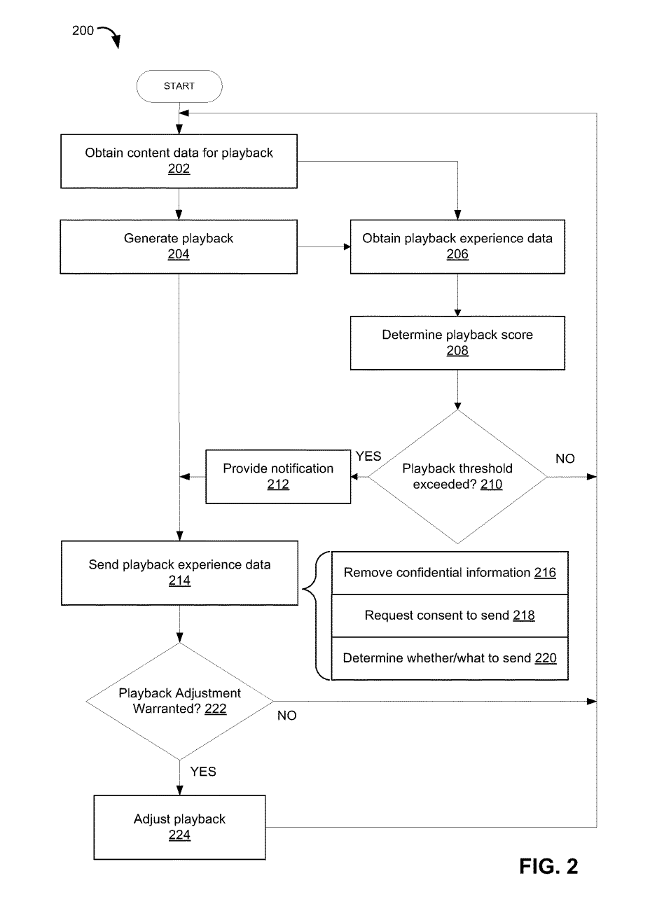

FIG. 2 depicts an exemplary computer-implemented method 200 of real-time playback experience diagnostics and notification. The method 200 may be implemented by the processor 102 (FIG. 1) and/or other processor of the client device 100 (FIG. 1), and/or another processor. The implementation of each act of the method 200 may be directed by respective computer-readable instructions executed by the processor 102 and/or another processor or processing system, such as the instructions described above in connection with the example of FIG. 1. For example, the acts of method 200 may be implemented by one or more of the instructions of the playback diagnostics module 110.

Additional, fewer, or alternative acts may be included in the method 200. For example, the method 200 may not include adjustments to the playback. The order of the acts of the method may vary from the example shown in FIG. 2. For instance, notification may occur in parallel with, before, or after streaming adjustments. Some or all of the acts may be implemented in parallel, continuously, or concurrently. For example, acts 204 and 206 may be performed in parallel. A number of the acts may be implemented periodically or continuously such that a playback score may be periodically updated, or multiple playback scores may be calculated concurrently. The notifications of act 212 may be delayed or suppressed based on previously provided notifications or other factors relevant to the playback experience.

The method 200 may begin with an act 202 in which content data is obtained for playback. The content data may be received by a media player application, or by a browser or other application implementing a media player. The content data may be obtained via a network connection and/or other sources. The content data may include various types of data in addition to the raw data used to generate playback. For instance, the content data may include data directly or indirectly indicative of the data source, the content type (e.g., video type, such as live versus on-demand, unencrypted versus encrypted, the encoding profile, resolution, etc.), and/or other characteristics of the content, content data, and/or any other factor or parameter that may affect or otherwise be determinative of playback quality. Alternatively or additionally, the act 202 may include obtaining such data in addition to the raw data used to generate playback.

The playback is generated in an act 204 based on the content data. For instance, a video and/or audio stream is generated by a media player. The manner in which the stream and other playback features are generated may vary.

In an act 206, playback experience data is obtained for the playback session. The playback experience data may include and/or be based on the content data and/or the generated playback. The playback experience data may thus be collected from data obtained during implementation of the acts 202 and/or 204. The playback experience data may be obtained via execution of the instructions of the module 110 (FIG. 1). Playback experience data may be obtained from multiple sources and may be indicative of playback quality (e.g., streaming video quality), such as events affecting playback quality. The playback experience data may be obtained in various ways. For instance, in some cases, the playback experience data is obtained by querying the media player 106 (FIG. 1). For example, the module 110 may generate and send a query requesting rendered video stream statistics of the media player 106. Alternatively or additionally, the playback experience data may be automatically provided on a periodic basis by the media player 106 or other component or entity involved in the playback (e.g., a streaming platform). The playback experience data may indicate network quality, content quality, and/or characteristics of the generated playback. The playback experience data may also include data representative of, or otherwise associated with, previously implemented actions of the adaptive playback instructions 124 (FIG. 1) during the playback session.

One or more playback scores are determined in an act 208 based on the playback experience data. The playback score(s) may be determined via execution of the instructions of the module 110 (FIG. 1). The playback score(s) may be determined in various ways, as described herein. In some cases, one or more counters are used. Each playback score may thus be a single, scalar quantity (e.g., 72). Alternatively or additionally, the playback score(s) is (are) determined via one or more functions taking the data obtained in the act 206 as inputs. The function may then apply weights (e.g., coefficients) or implement other processing to determine the playback score. Any number of playback scores (e.g., sub-scores) may be integrated or otherwise combined into a single playback score. Each playback score may be generated based on various types of playback experience data.

In the example of FIG. 2, the playback score(s) is (are) compared to one or more playback thresholds in a decision block 210. In some cases, the playback threshold is a single scalar quantity (e.g., 70). The playback scores may be analyzed in other ways. For example, in some cases, the analysis includes a comparison with a dataset, such as a distribution.

The decision block 210 passes control to an act 212 if the playback score exceeds the threshold for notification of a detected or identified playback issue. In some cases, details of a specific playback issue are provided in the notification. A playback issue may be indicative of an issue perceptible to the viewer. In some cases, further analysis or processing is implemented in the act 212 to determine when and/or whether to provide the notification of the playback issue. If no playback issue is detected, then control returns to the act 202 for further data collection for playback and playback diagnostics.

In the example of FIG. 2, playback experience data is shared or otherwise transmitted to another party in an act 214. The playback experience data may include the playback experience data used to determine the playback score and/or additional playback experience data. The playback score(s) may also be transmitted. The act 214 may include transmission to one or more servers, including, for instance, a server acting as, or affiliated with, a content source or other entity associated with the streaming. In some cases, confidential information is removed in an act 216 from the playback experience data before the transmission. Alternatively or additionally, the act 214 is implemented if the viewer provides consent in response to a request provided in an act 218, e.g., via the notification. An input may be received via one or more user interfaces in response to the notification. The act 214 may also an act 220 in which a determination of what data to send and/or whether to send such data is made. The determination may be made in accordance with a variety of factors or conditions in addition to whether the user has provided consent.

If the media player includes adaptive playback functionality via, e.g., adaptive playback instructions 124 (FIG. 1), a decision block 222 determines whether any playback adjustment is warranted. The determination may be made by instructions in the playback diagnostics module 110 (FIG. 1) and/or other instructions, such as the adaptive playback instructions 124. The determination may be made based on the type playback issue(s) identified, the playback score(s), and/or the playback experience data. Other types of data may also be used in the determination, including, for instance, the content data. The determination may occur concurrently with other analysis of the playback score, such as the comparison of the playback score to the playback threshold. Playback adjustments may be implemented during other acts of the method 200. If no video stream adjustments are warranted, control may return to the act 202 to continue the method 200 in connection with new content data.

If video stream adjustment is warranted, the video stream is adjusted in an act 224. The adjustment may involve various aspects of the playback, including, for instance, resolution, frame rate, audio bit rate, etc. The act 224 may be implemented by the adaptive playback instructions 124 (FIG. 1). In some cases, the adjustment may be followed by the generation of an updated playback score.

The acts 206, 208, 212 and the decision block 210 may be implemented before, after, or concurrently with playback. Playback generation in the act 204 may include some procedures that precede playback score determination and analysis, and other procedures that follow playback score determination and analysis. In that way, the content data may be processed enough to generate the playback experience data, while still leaving time for the playback score generation, analysis, and other processing. In some cases, adjustment of the playback may also occur before the content is rendered or otherwise provided to the end user.

The method of FIG. 2 is addressed in further detail below in the context of the example of FIG. 1.

### Playback Experience Data Collection

Playback experience data provides diagnostic information associated with the content, the current rendered video stream that is displayed, the computer network characteristics and/or other factors affecting the playback experience. Diagnostic information may be categorized as events that may potentially interrupt or affect playback. For example, an event may involve the video stream entering a buffering state or decrease in resolution of the rendered images and audio. The video player then determines the playback experience quality based on characteristics of the events. Event-based modeling may be compliant with, but not limited to, the W3C specification and/or HTML 5.

The data collection instructions 112 may query, listen, or receive data (e.g., playback experience data and/or or raw data) from a variety of sources, including, for instance, the original content, the streaming platform, the browser, other client applications, the network, and the operating system of the client device. The determination of the playback score is constructed from or based on inputs during the video streaming session. Metadata associated with video content may constitute one type of input of playback experience data originating from the content publishing source. The metadata may include characteristics of the video content such as the type of content. Types of content include indications of whether content is being broadcast live or is being accessed on demand, whether the content is encrypted and/or the type of encryption, encoding profiles, as well as the fidelity of the originally transmitted data quality (e.g., resolution or aspect ratio), and the like. Playback experience data may also be obtained based on characteristics of the source, such as the content provider. Characteristics of a content provider may include one or more content types that are served by the content provider. For example, a sports-casting content provider may serve categories of content that contain fast motion sequences, and a news-casting content provider may serve categories of content with relatively less movement.

Inputs associated with the network communication exchange between servers and the client device also provide playback experience data for collection via execution of the data collection instructions 112. For example, the media player may communicate with the content server and/or database via Asynchronous JavaScript and XML (AJAX) script. Hypertext Transfer Protocol (HTTP) status codes generated during course of such communication may be obtained via execution of the data collection instructions 112. For example, codes other than the HTTP status code “200” indicating a successful communication transmission may be collected and processed to assess the quality of the communications. Network communication conditions and status may be provided or inferred using other HTTP status codes and states. Time values associated with latency of received data and indications that a transmission has failed may additionally or alternatively be used to provide playback experience data.

Playback experience data further includes inputs indicating statistical information quantifying the quality of the video that is ultimately rendered on the display of the client device. Statistical data of this nature may be obtained by identifying, for instance, the aspect ratio of the displayed video stream, the screen resolution, bit rate, or number of frames dropped during the video stream. These statistics (as well as other obtained playback experience data) may be generated by the media player. Logged events, such as dropped frames, may be identified using video tags, which may, for instance, be set forth in accordance with the World Wide Web Consortium (WC3) specification for HTML5. Alternative or additional events may be defined outside the WC3 specification and/or using markup languages other than HTML5.

Playback experience data obtained via execution of the data collection instructions 112 are used to determine the playback score(s) in accordance with the playback score generation instructions 114.

### Playback Score and Issue Determination

The playback score generation instructions 114 use the playback experience data to determine the playback score(s). The playback experience data may include raw data, such as raw data generated or received by the media player, or any other data processed or available for reasons other than diagnostics. The playback experience data is aggregated or otherwise collected over a period of time during the playback session. The period of time may be predetermined and/or based on the playback experience data and/or other data.

The playback score generation instructions 114 may determine the playback score as a function of the playback experience data. The function may take a number of parameters as arguments, operands, or other inputs. For example, execution of the playback score generation instructions 114 may implement one or more counters to sum or integrate playback events over time. The final count of such playback events may then be used as an input for the function. In some cases, the function may include or apply weights to one or more of the input parameters. The weights may be useful for relatively emphasizing different types of playback experience data.

Computation of the playback score may be a summation of multiple sub-scores. Alternatively or additionally, each individual sub-score may be compared to a respective threshold. The playback score may be computed as a total of weighted sub-scores or a weighted average of sub-scores. The playback score may be optimized based on the customized elements or characteristics of the video player and/or respective content publisher.

In some examples, the playback score determination may include implementation of one or more counters. Each counter may be or include a single value determination based on the evaluation of playback experience data obtained via execution of the data collection instructions 112. The playback score may be determined for some or all events occurring during a playback session or may assess all events for a duration of time. Computation of the playback score may be conducted to generate a playback score representing the total number of inputs obtained, an aggregated value of the obtained inputs, or a combination thereof.

Various types of events may be counted in connection with the playback score determination. In some cases, the number of times that the rendered video stream buffers is tracked. Alternatively or additionally, the length of each buffering episode is determined. The number of times that the quality of the playback switches may be tracked. The number of times that a playback session prematurely terminates may be tracked. Each of these event types may be counted for a respective time frame and compared with a respective threshold.

Each threshold and time frame may be fixed or variable. Any one or more of the thresholds and time frames may be scaled or changed based on various factors, such as the presence of one or more other playback issues, previous or concurrent, during a playback session. The playback score may be calculated by the playback score generation instructions 114 in additional or alternative ways.

The playback score may be additionally or alternatively determined based on (e.g., as a function of) a type, source, trigger, frequency, intensity, and duration of one or more events and/or queried data. In some cases, a sub-score may be determined for one or more of these event factors. For instance, a frequency sub-score may be determined for a playback session to provide an indication of the frequency of playback issues during the session.

A trigger is an identification of the cause of an event or data query. Some triggers are indicative of a problem, while some are not. One non-problematic trigger is buffering caused by end user input (e.g., fast forwarding rewinding, or other seeking functions) with respect to the computation of the playback score. Some triggers may depend on or involve the content source, such as the quality of the original content. Resolution of the rendered video stream may constitute a problematic trigger only when the resolution of the displayed video is below a threshold relative to the original content quality because resolution of the rendered video stream is ultimately limited by the quality of the original content.

Frequency is indicative of the number of event occurrences. For example, the frequency of dropped frames influences whether the dropped frame in a video streaming session result in a reduction of playback experience quality. The frame rate of the rendered video stream needed to provide an acceptable quality of playback may be approximately sixteen frames per second. The acceptable quality of playback refers to the frequency of dropped frames that do not independently cause a playback issue to occur (i.e., cause the playback threshold to be exceeded). In one example, a loss of frames causing the video stream frame rate to drop below sixteen frames per second may constitute a playback quality event. Frequency or other sub-scores may be interdependent on other playback experience data. For video content including fast motion, the acceptable quality of playback may involve a higher number of frames per second.

The intensity of an event is indicative of the degree of impact on playback quality. Changes in network connectivity, such as changes in available bandwidth for video streaming, have an intensity indicative of the significance of the change in data transmission rates.

The duration of an event is indicative how long playback quality is affected. For example, the duration of a network connectivity event may include one or more time periods associated with loss of network connectivity and/or one or more time periods associated with a reduction in the available bandwidth of a network connection.

In order to anticipate the impact of events and queried data on playback quality during the streaming session, multiple events and multiple indicators (event type, trigger, intensity, duration, etc.) may be considered. Each of these factors may be provided as inputs to the playback score determination. Event modeling may be conducted via the video player and may follow W3C specifications for HTML5 or other web-based protocols.

A media player may determine a content type of a video stream based on an identification of the original source of the content and/or publisher of the video content. The content type may, alternatively, or additionally, be determined based on metadata associated with an individual piece of content.

Playback experience data, playback score, and a playback threshold are indicative of the playback quality (i.e., the quality of rendered video stream). Network quality may be indicated by playback experience data associated with the network connection during the streaming session. Content quality data may include information associated with the fidelity of the content that is sent to, or received, by client device 100. Content quality data may include comparative information based on the fidelity of the original content provided by a streaming service or other content provider and the fidelity of the rendered video stream.

Fluctuations in playback quality that do not visibly impact the rendered video may not merit notification. For example, a single dropped frame may not be perceptible to the end user. Multiple dropped frames may only be perceptible to the end user if the dropped frames are consecutive. The same number of dropped frames may indicate a significant reduction in quality for fast motion content but may be imperceptible when viewing content with less motion, such as a security camera feed of an empty space. In another example, some types of content encryption may require more processing capacity than other types of content encryption.

A combination of inputs providing playback experience data for an event may indicate the degree to which playback quality is affected. In such cases, the quality of the playback experience may depend upon the combined effects of different factors. For example, the amount of bandwidth and the amount of currently buffered content may affect the amount of time available to perform other tasks.

The playback score may include multiple sub-scores. Sub-scores may be separately generated and combined in order to ultimately produce a single, overall playback score. Examples of sub-scores are a network sub-score, a quality sub-score, and an experience sub-score. The playback score may be generated as a summation of these and/or alternative or additional sub-scores. Each of these individual sub-scores may have thresholds and/or weights that affect the overall playback score. Individual sub-score thresholds and/or a weight given to a sub-score may be indicative of its importance in determining the playback experience quality.

Alternatively or additionally, the sub-scores are evaluated separately. For instance, a playback issue may be detected if a respective sub-score is indicative of a certain number of events. However, the determination of whether the playback experience quality constitutes a playback issue warranting end user notification may be determined based on an analysis of multiple sub-scores (e.g., all of the sub-scores). Sub-scores may have a priority order of thresholds, a minimum number of thresholds, or separate scores. In some examples, the playback score may refer collectively to multiple other scores.

Determination of playback issues through the playback score and comparison of the playback score to a playback threshold may constitute one or more procedures that are systematically applied to all playback sessions. Computation of the playback score using a systematically applied procedure may include the calculation of multiple sub-scores, application of sub-score thresholds, and weighting of sub-scores when determining the overall playback score. Thus, a systematically applied procedure provides playback issue identification reflective of the set of characteristics, specific combination of sources, and the conditions needed to create a perceptible change in playback quality that are unique to each, individual playback session.

In some examples, one of multiple playback thresholds may be applied to the overall playback score. The applied playback threshold may be selected by the player based on content type (e.g., video genre or other characteristics descriptive of the content, such as fast or slow action levels). The selection of the playback threshold against which the playback score is compared may be determined based on playback experience data obtained by the video player prior to or during the commencement of the video streaming session. Determining the playback score may use customized calculation methods in the same manner based on content specific or other obtained playback experience data associated with a particular video streaming session.

The use of a playback score by the playback score analysis instructions 116 provides diagnostic capabilities while minimizing or limiting the processor demand. Determination of the playback score is negligible relative to the processing requirements for rendering the video stream. Accordingly, diagnostic operations may be effectively performed without impairing video playback in a way perceptible to the viewer. The disclosed systems and methods may thus provide diagnostics even when playback issues are caused by processor capacity limitations.

### Notification and Data Transfer

Execution of the notification instructions 118 generates and provides notifications for display indicating that a playback issue has been detected. The notification may include a visual and/or aural output to the end user. The notification may appear in the same window as the streaming video, in a separate window, or in another portion of the display of the client device. Data collected and associated with the detected playback issue may be displayed via the notification. For example, a text description of the detected issue, error code, and/or ticket ID may be provided. Real-time notification is provided via the browser or application during the video streaming session. Additionally or alternatively, playback issue information may be provided to the end user via other interfaces, such as email or other messages. An entity receiving the detailed event data for the detected issue may also follow-up with the end user through various communication channels.

The timing of the notification may vary. In some cases, a notification may be rendered by the video player at the point in time that the playback issue has been detected (e.g., when a threshold has been exceeded). In other cases, the timing of the notification display may be delayed in order to reduce the interruption of the video streaming experience. Notifications may be delayed and/or consolidated for display to provide a single notification at the end of the video stream, upon an interruption in the video stream, or until the end user interacts with the video player. Notifications may be delayed, consolidated, or suppressed based on the notifications that have been displayed previously in the video streaming session, as well as based on the responses provided by the end user to such notifications.

Notifications for a playback issue may include multiple indicators. For example, a first notification may indicate that in the issue has been detected, and a second notification may request permission from the end user to share detailed event data associated with the identified issue. The first notification may be designed to minimize distraction, consisting only of an audio tone or a graphic element. A second notification containing more detailed information associated with the experienced issue may be provided at the end of the video stream, when the video stream has been interrupted, or at another delayed time. Such multiple notifications can be used to provide confirmation that the issue has been detected by the video player immediately following the issue, while delaying the need for end user input until a natural pause in the video streaming session. The timing of the notification may be established in some examples based on preferences of the end user associated with the browser, the client application, the video player, or the content provider.

Frequency of the display of notifications may positively or negatively impact the degree of satisfaction experienced by the end user during a video streaming session. Controlling the frequency and impact of the notification may limit distraction of the viewer during a playback session. Conversely, the frequency of notification also provides useful and timely information, thereby indicating the responsiveness of the video player to a bad viewing experience. The notification may be configured to minimize the potential for distraction and maximize the potential for a positive impact. For example, the type, volume, size, color and/or other characteristics of a notification may be selected by the video player. In some cases, the characteristics may be selected to complement the video concurrently being rendered. The timing of the display of notifications may also be optimized for customer satisfaction and to maximize end user input in interactive notifications. The display of notifications may be postponed until the end of the streaming session or until the end user interacts with the playback session (e.g., by pausing, seeking, or initiating some other action that interrupts playback). The display of notifications may be postponed until the user interacts with any portion of the browser and/or application. Timing the display of notifications with other user input actions may improve the likelihood that the end user will see or hear the notification. A notification may also have a maximum duration of display time to limit potential distraction of the viewer.

In some examples, the frequency or amount of notifications during a single streaming session may be limited. For instance, notifications may be limited to a certain frequency or other level based on the identity of the user, type of device, or other characteristic of the playback session. If the same issue occurs multiple times during one streaming session, then the notification addressing the repeated issue may be postponed to limit user distraction.

The notification may also include a mechanism for the end user to provide consent to further distribution of playback issue or event data in accordance with the data transfer instructions 120. The data may be transmitted to various entities or third parties, such as a content publisher, a device support service, a streaming service provider, or other party associated with factors that may affect playback quality. The notification may prompt the user to provide input to the video player indicating whether the user provides consent to sharing the collected event data. The notification may include a dialog box or other graphical interface element. Consent may allow the event data to be sent for aggregation and/or analysis. Consent may further result in opening a customer support request for resolution and follow-up after the end of the playback session. The end user may be provided with a contact for a customer support or trouble shooting service associated with the video player or content provider to continue communication about the detected issue. End user identification information may be anonymized or removed prior to distribution.

Privacy of the end user is protected through either removal of confidential information and/or user consent to distribution. For example, in some cases, no playback experience data containing playback experience data is distributed if the end user does not provide consent. Playback experience data may also not be shared in the event that no response to a notification is received.

Consent-based distribution of playback issue data also beneficially indicates a relative importance of the issue to an end user. A user selecting a particular playback issue to share is likely indicating that the issue is of relatively higher importance. The user is more likely to interact with, and share, the notification if the identified issue is of elevated importance to the end user.

The notification procedure may provide further end user benefits. For instance, end user satisfaction is increased by providing the user with confirmation that a problem has been identified. End user satisfaction is also increased by providing the user with an opportunity receive follow-up support associated with the problem.

The transmitted event data may be identified as an issue report or event report and may include an associated ticket ID. Playback experience data selected for inclusion in the report may be limited to specific event conditions bearing a relationship to the playback score at or near the time that the playback threshold is exceeded.

Related playback issue data may include only relevant data associated with the playback issue identified by the notification. Relevant data may include selective identification of playback experience data that is contributory or causal of the playback score exceeding the playback threshold. Selective identification beneficially reduces the quantity of distributed playback issue data for analysis.

Issue reports or event reports provide detailed playback issue data and may be generated by the notification module. Reports may include playback experience data obtained by the module 106 associated with the identified playback issue. The detailed report data may selectively include playback experience data identified as contributing or causing the playback issue. Contributing events are considered to affect the playback score more heavily than other events influencing the playback score. A causal event is an event having the biggest impact on the playback score at the time the playback threshold is exceeded.

Reports may provide a package including playback issue data. The package allows for efficient distribution to multiple entities by the video player. Distribution of detailed event data associated with specific playback issues may result in resolution of the specific playback issue, as well as result in improved content publication, improved video streaming services, and optimization of future video streaming experiences.

Recipients of the playback issue data include entities providing services or products associated with the video streaming session. For example, an issue report or event report may be sent simultaneously to servers associated with individual entities the video player developer, a video player provider, a streaming service provider, a customer service provider, an analytics service provider, a content owner, a content publisher, and/or any other provider associated with the streaming video session. Relevant portions of the diagnostic information may be selectively identified by the notification module based on predetermined parameters associated with each recipient.

The reports enable recipient entities to aggregate highly detailed information from many video players across many client devices and resolve similar or repeated playback issues that occur amongst a wide range of streaming circumstances, from multiple sources, and from a variety of video player configurations causing similar playback issues.

Upon receipt of end user consent, the report may be immediately generated and transmitted to various parties. One or more reports may be transmitted upon receipt of end user consent but before the end of the video streaming session. Streaming applications, video players, content providers, and other parties may use the reports to adjust their respective products and services over time, facilitating the effective resolution and improvement of playback quality.

Issue and event reports can be customized based on the needs of each individual recipient. The content of the report may be tailored for each recipient. For example, content identification data, time, and/or frame location at the time of a triggering event may be provided to a media house to identify and resolve repeating issues associated with its served content. Customization minimizes computational loads and enhances the issue resolution speed for an individual recipient by reducing the amount of non-actionable data received. Accordingly, large quantities of data that do not significantly contribute to the cause of the playback issue may be eliminated from issue and event reports by the video player before distribution. Customization further reduces the quantity of data received by an individual, so that only data that is specific to the recipient is included in the customized report.

In one example, customized issue and event reports may be beneficial to a content publisher to isolate characteristics of the original content data causing playback issues in multiple computing environments. Receiving event reports identifying problematic frame locations or video segments in the original content data allows the content provider to correct the original content data that is published, preempting future issues with the same video. In another example, customer support and video player development providers may direct specific event data associated with an identified issue to content providers so that issues can be fixed at the source of the problem.

### Adaptive Playback

Determination of the playback score may be implemented in connection with video players with adaptive playback features. The adaptive playback instructions 124 and/or other instructions may cause the processor to periodically or continually access the playback score, the results of the analysis of the playback score (e.g., comparison with a playback threshold), and/or other playback experience data during a playback session, to determine whether to adjust playback. For instance, in response to such data obtained in real-time, the adaptive playback instructions 124 may cause the processor to change the quality of the playback (e.g., the video quality) mid-stream in order to prevent a buffering state. Changes in quality may be made by increasing or decreasing the bit rate, the resolution of the rendered video stream, and/or other parameters.

Changes to the playback provide new playback experience data. Such new data, in turn, results in updates to the playback score during the video streaming session. For example, the playback score may be updated based on the increase/decrease of the bit rate. When playback issues are resolved via adaptive playback without creating a perceptible change in the rendered video stream, the playback score may be reduced or updated. The value of the playback score following complete resolution of a potential playback issue ultimately reflects a playback that does not exceed the playback threshold. Alternatively, or additionally, if the adaptive video player cannot recover from the issue without a perceptible change in quality of the rendered video stream and/or a perceptible interruption of the video stream, the playback score may be updated, but the playback threshold may still be exceeded. For example, a buffering state may be effectively prevented, but the playback threshold may still be exceeded due to perceptible reductions in picture quality, causing another notification to be generated. In other examples, adaptive playback may provide changes in playback quality with respect to buffering and resolution. However, one or more perceptible reductions in video quality may still occur. Any one or more perceptible reductions in video quality resulting from adaptive playback changes may still affect the playback score enough to exceed the threshold. In some instances, successful resolution of playback issues may trigger the generation of proactive notifications by the notification module to provide additional end user satisfaction associated with the streaming session. Some video players may include adaptive playback features that are not impacted by the playback score and other video players may be implemented without an adaptive playback module at all.

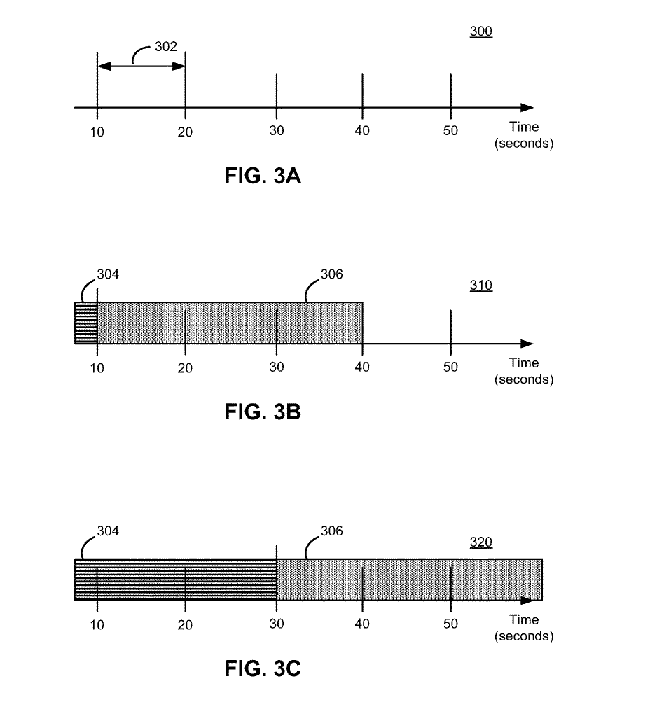

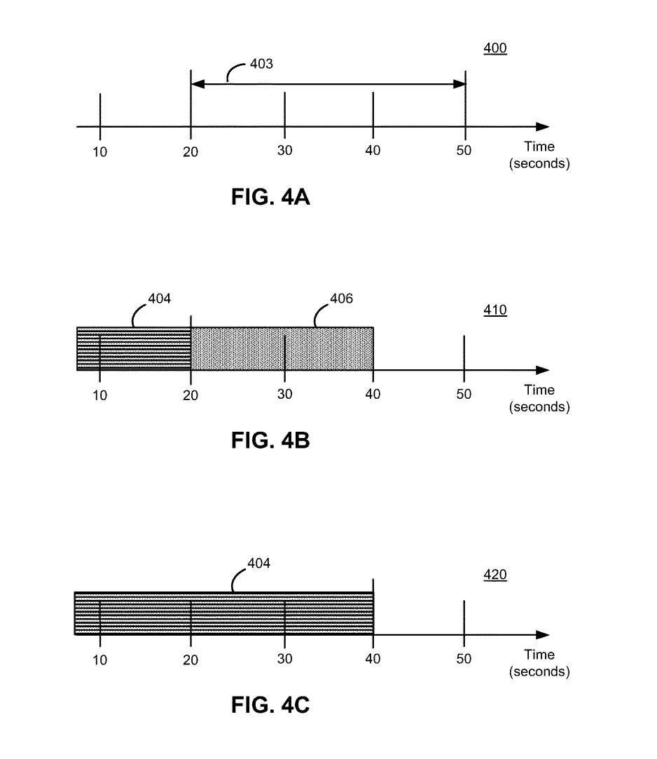

FIGS. 3A-3C and FIGS. 4A-4C illustrate two example event scenarios that may potentially affect the quality of playback in video streaming. In these two examples, an end user engages in video streaming using the client device 100. For example, a viewer may watch a movie online via a subscription streaming video provider. The time axis represents the time, in seconds, beginning with the initial playback in the video streaming session; e.g., when the movie begins playing. In these examples, the web-based application downloads approximately thirty seconds in advance of when the content will be displayed to the end user. Accordingly, at time t=10 seconds, video content is downloaded up to approximately t=40 seconds (FIG. 3A). Because video content is buffered, some events may occur and be resolved without any perceptible effect to the rendered video quality.

Event 302 of FIG. 3A, such as a network failure, may prevent buffered video content 306 from being downloaded between t=10 seconds to t=20 seconds. As shown in FIG. 3B, the effect of the event does not impact the content 304 immediately at ten seconds. As illustrated in FIG. 3C, at current time of t=30 seconds into the video streaming session, the viewed content 304 has not been impacted. The downloaded content catches up once the network issue is resolved. A potential issue may be identified by these events via the playback score. However, the potential issue is rectified and the playback score is adjusted such that the playback score does not exceed the playback threshold in the illustrated timeline. Thus, no notification is generated because the issue has been successfully resolved without affecting the perceptible video streaming quality of the end user. The display of notifications is thus correlated with the implementation of corrections during playback.

In contrast, event 403 of FIG. 4A results in a perceptible impact upon playback quality. A playback issue is therefore identified. The duration of event 403 is thirty seconds, but only twenty seconds worth of content has been downloaded when event 403 begins at time t=20 seconds. As a result, all of the stored content 406 has been rendered as content 404 at time t=40 seconds. The video stream then enters a buffering state until event 403 is resolved, allowing additional content to be downloaded. The playback score exceeds the playback threshold, identifying the buffering state as a playback issue.

In other examples, events 302 and 403 may occur simultaneously and may originate from the circumstances of a variety sources. In some examples, both events 302 and 403 may result in exceeding the playback score. The amount of the currently buffered content during the course of a video streaming session may contribute to the cause of other playback issues.

The procedure used to determine whether circumstances of the playback session result in a playback score exceeding the playback threshold may be integrated with other components or aspects of the player. Real-time event logging and evaluation of the cumulative effect of the logged events during a playback session allow the player to recover in real-time. Further, real-time resolutions of potential playback issues are taken into account in the generation of the playback score. Thus, notifications are only generated when perceptible playback quality issues have arisen. By limiting notifications to playback issues that result in perceptible changes in the video stream, notifications associated with resolved issues are not generated. Thus, disruption to the playback experience is also limited.

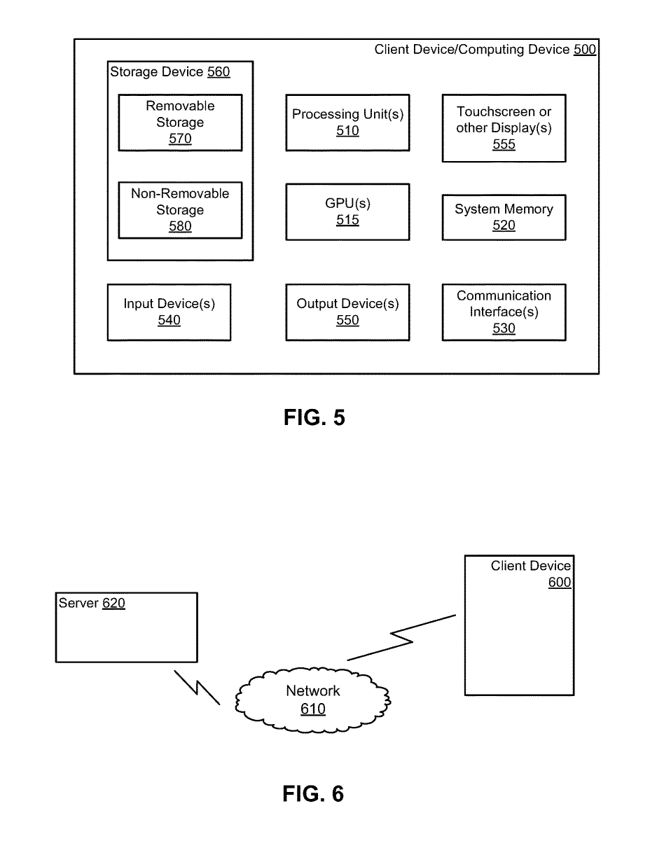

With reference to FIG. 5, a simplified client device/computing environment 500 may be used to implement one or more aspects or elements of the above-described methods devices and/or systems. The computing environment 500 may be used by, incorporated into, or correspond with, the client device 100 (FIG. 1) or one or more elements thereof. For example, the computing environment 500 may be used to implement real-time playback experience diagnostics and notification for playback provided by the client device 100. The computing environment 500 may be a general-purpose computer system used to implement one or more of the acts of the method described in connection with FIG. 2. The computing environment 500 may correspond with one of a wide variety of computing devices, including, but not limited to, personal computers (PCs), tablet and other handheld computing devices, wearable computers, laptop or mobile computers, communications devices such as mobile phones, multiprocessor systems, microprocessor-based systems, set top boxes, programmable consumer electronics, network PCs, minicomputers, mainframe computers, audio or video media players, and game consoles.

The computing environment 500 has sufficient computational capability and system memory to enable basic computational operations. In this example, the computing environment 500 includes one or more processing unit(s) 510 that may be individually or collectively referred to herein as a processor. The computing environment 500 may also include one or more graphics processing units (GPUs) 515. The processor 510 and/or the GPU 515 may include integrated memory and/or be in communication with system memory 520. The processor 510 and/or the GPU 515 may be a specialized microprocessor, such as a digital signal processor (DSP), a very long instruction word (VLIW) processor, or other microcontroller, or may be a general purpose central processing unit (CPU) having one or more processing cores. The processor 510, the GPU 515, the system memory 520, and/or any other components of the computing environment 500 may be packaged or otherwise integrated as a system on a chip (SoC), application-specific integrated circuit (ASIC), or other integrated circuit or system. Computing device 500 may include a separate, additional processor dedicated to handling the processing load for real-time video playback experience diagnosis and notification, including implementation of the playback experience diagnosis and notification techniques described herein. The processor unit 510 is configured to execute a number of instruction sets stored in storage device 560, removable storage 570, non-removable storage 580, and/or system memory 520. The instruction sets may be arranged as respective software modules. The modules or other instruction sets may be integrated to any desired extent.

The computing environment 500 may also include other components, such as a communications interface 530. One or more computer input devices 540 (e.g., pointing devices, keyboards, audio input devices, video input devices, haptic input devices, devices for receiving wired or wireless data transmissions, etc.) may be provided. Various output devices 550, including touchscreen or touch-sensitive display(s) 555, may also be provided. The processing units 510 are configured to obtain video playback quality data associated with a real-time video streaming session as it is rendered on display 555. The playback quality data and or playback score may be representative of the quality of the playback experience provided to the end user through display 555. The output devices 550 may include a variety of different audio output devices, video output devices, and/or devices for transmitting wired or wireless data transmissions.

The computing environment 500 may also include a variety of computer readable media for storage of information such as computer-readable or computer-executable instructions, data structures, program modules, or other data. Computer readable media may be any available media accessible via storage devices 560 and includes both volatile and nonvolatile media, whether in removable storage 570 and/or non-removable storage 580.

FIG. 6 is a block diagram of a client server model for improving real-time video playback experience diagnostics and notifications. The client server model includes one or more client devices 600 in communication with one or more servers 620 via network 610. The network 610 may include one or more wired or wireless data links enabling the transmission and reception of data between computer systems or other electronic devices. When data is transferred over the network 610 or through another communications connection (hardwired, wireless, or a combination of hardwired and wireless), the network 610 acts as a transmission medium. Software instruction sets may be carried via transmission media including network and/or data links in the form of computer-executable instructions or data structures that can be accessed by a general purpose or special purpose computer.

Computer readable media may include computer storage media and communication media. Computer storage media may include both volatile and nonvolatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by the processing units of the computing environment 500.

The diagnostic and notification techniques improving video streaming quality described herein may be implemented in computer-executable instructions, such as program modules, being executed by the computing environment 500. Program modules include routines, programs, objects, components, data structures, etc., that perform particular tasks or implement particular abstract data types. The techniques described herein may also be practiced in distributed computing environments where tasks are performed by one or more remote processing devices, or within a cloud of one or more devices, that are linked through one or more communications networks. In a distributed computing environment, program modules, such as a set of software instructions, may be located in both local and remote computer storage media including media storage devices.

The techniques may be implemented, in part or in whole, as hardware logic circuits or components, which may or may not include a processor. The hardware logic components may be configured as Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and/or other hardware logic circuits.

Any of the foregoing aspects of the client devices may be implemented as acts of a computer-implemented method. For instance, in one aspect, the computer-implemented method includes obtaining, at the client, playback experience data indicative of streaming video quality. The method determines a playback score based on the obtained playback experience data and compares the playback score to a playback threshold. The method also provides a notification for display at the client and the playback score exceeds the playback threshold.

In one aspect, a method includes obtaining playback experience data indicative of playback quality of a playback at a client, determining a playback score for the playback based on the obtained playback experience data, analyzing the playback score to determine whether a playback issue is present, and providing a notification at the client indicating that the playback issue is present.

In another aspect, a method includes obtaining playback data indicative of playback quality of a playback, determining a playback score for the playback based on the obtained playback data, comparing the playback score to a playback threshold, the playback threshold being indicative of a playback issue of a degree capable of being perceptible to an end user, and providing a notification regarding the playback issue when the playback score exceeds the playback threshold.

In yet another aspect, a system includes a memory in which instructions are stored, and a processor coupled to the memory and configured via execution of the instructions to obtain playback experience data indicative of playback quality, determine a playback score based on the obtained playback experience data, the playback score being indicative of an event affecting the playback quality, analyze the playback score to determine whether a playback issue is present, provide an interactive notification when the playback issue is present, wherein the interactive notification requests end user consent to distribute report data indicative of the playback issue, and send the report data to a server upon receipt of an indication of the end user consent.

In connection with any one of the aforementioned aspects, the methods and systems may alternatively or additionally include any combination of one or more of the following aspects or features. Analyzing the playback score includes comparing the playback score with a threshold. At the client, end user consent to distribute report data indicative of the playback quality in response to the displayed notification is received. The report data is sent to a server. The playback experience data includes data indicative of rendered video content quality of the playback. The playback experience data is indicative of a content type of the playback. The playback is adjusted in accordance with whether the playback issue is present. The obtained playback experience data is associated with an event in the playback, and the playback score is indicative of a frequency, intensity, or a duration of the event. Obtaining the playback experience data includes querying a media player for data representative of the playback. The playback score includes a plurality of sub-scores including one or more of a network quality sub-score, a content quality sub-score, and an experience quality sub-score. Determining the playback score includes weighting each sub-score of the plurality of sub-scores, and aggregating the weighted sub-scores to determine the playback score. Analyzing the playback score includes comparing each sub-score to a respective sub-score threshold. Analyzing the playback score includes determining how many of the sub-score thresholds are exceeded. Obtaining the playback experience data includes querying an operating system of the client. A bit rate for the playback is decreased in response to whether the playback score exceeds the playback threshold. User interaction with the notification indicative of end user consent to share data indicative of the playback issue is received, and report data indicative of the playback issue is sent. The playback score is indicative of a frequency of frame drop events of the playback and a duration of the frame drop events.

The present invention has been described with reference to specific examples, which are intended to be illustrative only and not to be limiting of the invention. It will be apparent to those of ordinary skill in the art that changes, additions, and/or deletions may be made to the disclosed embodiments without departing from the spirit and scope of the invention.

The foregoing description is given for clearness of understanding only. No unnecessary limitations should be understood therefrom because modifications within the scope of the invention may be apparent to those having ordinary skill in the art.

1. A method of real-time playback diagnostics of a playback at a client, the method comprising:
obtaining, by a media player executing on the client, playback experience data indicative of playback quality of the playback at the client;
determining, by the media player, a playback score for the playback based on the obtained playback experience data;
analyzing, by the media player, the playback score to determine whether a playback issue is present;
adjusting, by the media player, the playback in accordance with whether the playback issue is present;
providing, by the media player, a notification at the client, the notification indicating that the playback issue is present; and
controlling, by the media player based on a characteristic of the playback, an aspect of the notification to complement video concurrently being rendered by the media player.

2. The method of claim 1, wherein analyzing the playback score comprises comparing the playback score with a threshold.

3. The method of claim 1, further comprising:
receiving, at the client, end user consent to distribute report data indicative of the playback quality in response to the displayed notification; and
sending the report data to a server.

4. The method of claim 1, wherein the playback experience data comprises data indicative of rendered video content quality of the playback.

5. The method of claim 1, wherein the playback experience data is indicative of a content type of the playback.

6. (canceled)

7. The method of claim 1, wherein:
the obtained playback experience data is associated with an event in the playback; and
the playback score is indicative of a frequency, intensity, or a duration of the event.

8. The method of claim 1, wherein obtaining the playback experience data comprises querying a media player for data representative of the playback.

9. The method of claim 1, wherein the playback score comprises a plurality of sub-scores including one or more of a network quality sub-score, a content quality sub-score, and an experience quality sub-score.

10. The method of claim 9, wherein determining the playback score comprises:
weighting each sub-score of the plurality of sub-scores; and
aggregating the weighted sub-scores to determine the playback score.

11. The method of claim 9, wherein analyzing the playback score comprises comparing each sub-score to a respective sub-score threshold.

12. The method of claim 11, wherein analyzing the playback score comprises determining how many of the sub-score thresholds are exceeded.

13. The method of claim 1, wherein obtaining the playback experience data comprises querying an operating system of the client.

14. A method of real-time playback diagnostics of a playback at a client, the method comprising:
obtaining, by a media player executing on the client, playback data indicative of playback quality of the playback at the client;
determining, by the media player, a playback score for the playback based on the obtained playback data;
comparing, by the media player, the playback score to a playback threshold, the playback threshold being indicative of a playback issue of a degree capable of being perceptible to an end user;
adjusting, by the media player, the playback in accordance with whether the playback issue is present;
providing, by the media player, a notification at the client regarding the playback issue when the playback score exceeds the playback threshold; and
controlling, by the media player, a timing aspect of the notification based on a characteristic of the playback.

15. The method of claim 14, further comprising decreasing a bit rate for the playback in response to whether the playback score exceeds the playback threshold.

16. The method of claim 14, further comprising:
receiving user interaction with the notification indicative of end user consent to share data indicative of the playback issue; and
sending report data indicative of the playback issue.

17. The method of claim 14, wherein the playback score is indicative of a frequency of frame drop events of the playback and a duration of the frame drop events.

18. A system of real-time playback diagnostics of a playback at a client, the system comprising:
a memory in which instructions for a media player to be executed on the client are stored; and
a processor coupled to the memory and configured via execution of the instructions to:
obtain, by the media player, playback experience data indicative of playback quality of the playback at the client;
determine, by the media player, a playback score based on the obtained playback experience data, wherein the playback score is indicative of an event affecting the playback quality;
analyze, by the media player, the playback score to determine whether a playback issue is present;
adjust, by the media player, the playback in accordance with whether the playback issue is present;
provide, by the media player, an interactive notification at the client when the playback issue is present, wherein the interactive notification requests end user consent to distribute report data indicative of the playback issue;
control, by the media player, a timing aspect of the interactive notification based on a characteristic of the playback; and
send, by the media player, the report data to a server upon receipt of an indication of the end user consent.

19. The system of claim 18, wherein the processor further executes the instructions to query a media player to obtain the playback experience data.

20. The system of claim 18, wherein the processor further executes the instructions to determine a plurality of sub-scores, to weight each sub-score of the plurality of sub-scores, and aggregate the weighted sub-scores to determine the playback score.

21. The method of claim 1, wherein the aspect is a size of the notification or a color of the notification.

22. The method of claim 1, wherein controlling the aspect comprises controlling a timing of the notification.

23. The method of claim 14, wherein controlling the timing aspect comprises limiting a frequency of notifications.

24. The method of claim 14, wherein controlling the timing aspect comprises postponing the notification until an end of the playback.

25. The method of claim 14, wherein controlling the timing aspect comprises postponing the notification until a user interacts with the media player.
